(19) United States
(12) Patent Application Publication
(10) Pub. No.: US 2010/0327751 A1
(43) Pub. Date: Dec. 30, 2010

(54) SELF-BALLASTED LAMP AND LIGHTING EQUIPMENT

(75) Inventors: Erika Takenaka, Yokosuka-Shi (JP); Shigeru Osawa, Yokosuka-Shi (JP); Yusuke Shibahara, Yokosuka-Shi (JP); Takeshi Hisayasu, Yokosuka-Shi (JP); Kazuto Morikawa, Yokosuka-Shi (JP); Tomohiro Sanpei, Yokosuka-Shi (JP); Mokoto Sakai, Yokosuka-Shi (JP)

Correspondence Address: DLA PIPER LLP US, P. O. BOX 2758, RESTON, VA, 20195, US

(73) Assignees: TOSHIBA LIGHTING & TECHNOLOGY CORPORATION, YOKOSUKA-SHI (JP); KABUSHIKI KAISHA TOSHIBA, MINATO-KU (JP)

(21) Appl. No.: 12/825,956

(22) Filed: Jun. 29, 2010

(30) Foreign Application Priority Data
Jun. 30, 2009 (JP) 2009-155922

(51) Int. Cl. H01J 13/32; H05B 37/02

(52) U.S. Cl. 315/113; 315/294

(57) ABSTRACT

The present invention provides a self-ballasted lamp which efficiently conducts heat of a plurality of LED chips of a light emitting module to its holder, and can prevent the temperature rise of the LED chips. The holder has a base portion, an edge portion provided at one end side of the base portion, which is thick at the base portion side thereof and thin at the distal end side thereof, and heat radiation fins provided at the other end side from the edge part and at the circumference of the base portion. The heat from the semiconductor light emitting elements is conducted from the base portion to the edge part and radiated therefrom. At this time, the edge part is thickened at the base portion side, wherein the thermal capacity is increased, and the heat conduction is improved.

### INCORPORATION BY REFERENCE

The present invention claims priority under 35 U.S.C.§119 to Japanese Patent Application No. 2009-155922 filed on Jun. 30, 2009. The contents of these applications are incorporated herein by reference in their entirety.

### FIELD

The present invention relates to a self-ballasted lamp using semiconductor light-emitting elements and lighting equipment using the self-ballasted lamp.

### BACKGROUND

Conventionally, in a self-ballasted lamp using LEDs as semiconductor light-emitting elements, a light emitting portion using an LED chip is attached to one end side of a metal-made holder, and a globe that covers the light-emitting portion is attached thereto. A cap is attached to the other end side of the holder via an insulative member, and a lighting circuit is accommodated inside the insulative member.

An SMD (Surface Mount Device) package in which a light emitting body having LED chips mounted thereon and having a connection terminal is mounted, and a COB (Chip On Board) module having a number of LED chips mounted on a substrate as described in, for example, Japanese Laid-Open Patent Publication No. 2009-37995, are used for the light-emitting portion.

In the case of the SMD package, since the SMD package may be dispersed and disposed on the surface of one end side of its holder, and the heat generating parts are dispersed, the heat of the LEDs can be efficiently conducted to the holder and radiated to the outside thereof, wherein the temperature rise of the LEDs can be easily controlled. However, in the case of the COB module, since a number of LEDs are mounted on a substrate and the heat generating parts are concentrated, it is difficult to control the temperature rise of the LEDs unless the heat of a number of concentrated LEDs can be efficiently conducted to the holder.

In a self-ballasted lamp using a prior art COB module, sufficient attention has not been paid to efficient heat conduction of the heat of a number of concentrated LEDs to the holder.

The present invention was developed in view of such points, and it is therefore an object of the invention to provide a self-ballasted lamp capable of efficiently conducting the heat from a light-emitting module having a plurality of semiconductor light-emitting elements mounted on a substrate to its holder and controlling the temperature rise of semiconductor light-emitting elements, and lighting equipment using the same.

### SUMMARY

A self-ballasted lamp according to the present invention includes: a light emitting module having a light emitting portion having a plurality of semiconductor light emitting elements mounted on the surface of one side of a substrate; a holder which has a base portion, an edge part provided at one end side of the base portion, which is thick at the base portion side and thin at the distal end side, and heat radiating fins provided at the other end part side of the edge part and at the circumference of the base portion and in which the surface of the other side of the substrate is brought into contact with one end side surface of the base portion so as to enable heat conduction so that the light emitting portion of the light emitting module is positioned in an area at one end side of the base portion; a cap provided at the other end side of the holder; and a lighting circuit accommodated between the base portion of the holder and the cap.

Therefore, since the light emitting portion of the light emitting module is positioned in an area at one end side of the base portion of the holder, heat from a plurality of semiconductor light emitting elements can be absorbed by the base portion and be efficiently conducted, and can be efficiently radiated to the outside by the heat radiation fins, wherein the temperature rise of the semiconductor light emitting elements can be controlled. In addition, heat of the semiconductor light emitting elements is conducted from the base portion to the heat radiating fins and radiated therefrom, and the heat of the semiconductor light emitting elements can be conducted from the base portion to the edge part as well and radiated therefrom. Since the base portion side of the edge part is made thick, the thermal capacity of this portion is increased, and the heat conduction can be further improved.

Therefore, since the light emitting portion of the light emitting module is positioned in an area at one end side of the base portion of the holder, heat from a plurality of semiconductor light emitting elements can be absorbed by the base portion and be efficiently conducted, and can be efficiently radiated to the outside by the heat radiation fins, wherein the temperature rise of the semiconductor light emitting elements can be controlled.

The semiconductor light emitting element includes, for example, LEDs and ELs, etc.

The light emitting module includes, for example, a COB (Chip On Board) module having a plurality of LEDs mounted on a substrate, and having a sealing resin layer formed by coating with a transparent resin in which a fluorescent body is blended. The light emitting portion is composed of, for example, a plurality of LED chips and a sealing resin layer. In addition, although it is preferable that the light emitting portion of the light emitting module is positioned in an area at one end side of the base portion, a part thereof may be positioned outside the area.

The holder is formed of, for example, a metallic material, and the base portion may be formed on at least one end side. The other end side of the base portion may be used as a spacing part in which the lighting circuit is accommodated. The heat radiation fins include, for example, that which radially protrudes from the circumference of the base portion.

The cap includes, for example, that which can be connected to a socket of an E17 or E26 type general illumination bulb.

The lighting circuit includes, for example, a power source circuit for outputting a direct current of constant current, and supplies power to the semiconductor light emitting elements by wiring, etc.

Although a globe having translucency, which covers the light emitting module, or the like, may be provided at one end side of the holder, this is not requisite for the configuration of the present invention.

Also, in the self-ballasted lamp according to the present invention, the edge part is shaped so that one end side surface is flush with the base portion, and the other end portion surface is made into a tapered surface.

Therefore, it is possible to vary the thickness of the edge part.

Also, in the self-ballasted lamp according to the present invention, the tapered surface of the edge part is linked with the end portion of the heat radiating fins.

Therefore, heat conduction is enabled between the edge part and the heat radiating fins, wherein heat can be efficiently radiated.

In addition, in the self-ballasted lamp according to the present invention, the thermal capacity of the base portion is greater than the thermal capacity of the heat radiating fins.

Therefore, the heat from the semiconductor light emitting elements can be efficiently absorbed by the base portion, and can be conducted to the heat radiating fins, wherein temperature rise of the semiconductor light emitting elements can be controlled.

Also, in the self-ballasted lamp according to the present invention, a wiring hole which communicates one end side of the base portion and the other end side thereof with each other and enables wiring connection between the light emitting module and the lighting circuit with each other is formed in the holder, a relief portion to open the wiring hole in a state where the substrate is in contact with the base portion is formed in the substrate of the light emitting module.

Therefore, since the wiring hole formed at the base portion of the holder is opened by the relief portion formed at the substrate of the light emitting module, wiring connection between the lighting circuit and the light emitting module is facilitated while maintaining heat conduction from the light emitting module to the holder.

Although the wiring hole may be formed at the center of the base portion or at a position deviated from the center thereof, it is preferable that the wiring hole is formed at a position deviated from the center of the base portion since it is better for the semiconductor light emitting elements of the light emitting module to be arranged at a position corresponding to the center of the base portion in view of taking light distribution as a self-ballasted lamp into consideration.

It does not matter that the relief portion of the substrate may be of any shape such as a notched portion, a hole portion or a groove portion. A connector receiver is arranged in the vicinity of the relief portion in the substrate, and it may be configured that a connector of a connection wire wired from the lighting circuit through the wiring hole is connected to the connector receiver.

Further, the self-ballasted lamp according to the present invention is configured so that a hole portion which communicates one end side of the base portion and the other end side thereof with each other is formed in the holder, and a groove portion is formed from one end side of the hole portion toward the surrounding area of the holder on the surface of one end side of the holder, wherein a wiring hole is formed by the hole portion and the groove portion, which enables wiring connection between the light emitting module and the lighting circuit.

Accordingly, since the wiring hole is formed by the hole portion communicating one end side of the base portion and the other end side thereof with each other and the groove portion formed from one end side of the hole portion toward the surrounding area of the holder on the surface of one end side of the holder, wiring connection between the lighting circuit and the light emitting module can be facilitated while maintaining heat conduction from the light emitting module to the holder.

Although the hole portion of the wiring hole may be formed at any position of the base portion, it is preferable that, where the semiconductor light emitting elements of the light emitting module are arranged at a position corresponding to the center of the base portion in view of taking light distribution as a self-ballasted lamp into consideration, the hole portion of the wiring hole is formed at a position deviated from the center of the base portion so that heat from the semiconductor light emitting elements is efficiently conducted to the center of the base portion. In addition, the groove portion is opened outwardly by the edge part of the substrate in a state where the substrate of the light emitting module is in contact with the base portion of the holder, wherein the groove portion enables passing of wiring. It is configured that a connector receiver is arranged at the edge part of the substrate corresponding to the opening position of the groove portion of the holder, and a connector of connection wiring wired from the lighting circuit through the groove portion can be connected thereto.

In addition, lighting equipment according to the present invention includes: an equipment main body having a socket; and a self-ballasted lamp according to any one of claims 1 through 3, which is mounted in the socket of the equipment main body.

Therefore, heat radiation performance of the self-ballasted fluorescent lamp is excellent, and longer service life can be brought about.

### BRIEF DESCRIPTION OF THE DRAWINGS

FIG. 1 is a sectional view showing a self-ballasted lamp according to Embodiment 1;

FIG. 2 is a front elevational view showing a state where the holder of the self-ballasted lamp and the light emitting module thereof are observed from one end side;

FIG. 3 is a front elevational view showing a state where the holder of the self-ballasted lamp is observed from one end side;

FIG. 4 is a side elevational view showing the self-ballasted lamp;

FIG. 5 is a sectional view showing lighting equipment using the self-ballasted lamp;

FIG. 6 is a front elevational view showing a state where the holder of the self-ballasted lamp and the light emitting module thereof are observed from one end side, according to Embodiment 2; and

FIG. 7 is a front elevational view showing a state where the holder of the self-ballasted lamp and the light emitting module thereof are observed from one end side, according to Embodiment 3.

### DETAILED DESCRIPTION

Hereinafter, a description is given of embodiments of the present invention with reference to the drawings.

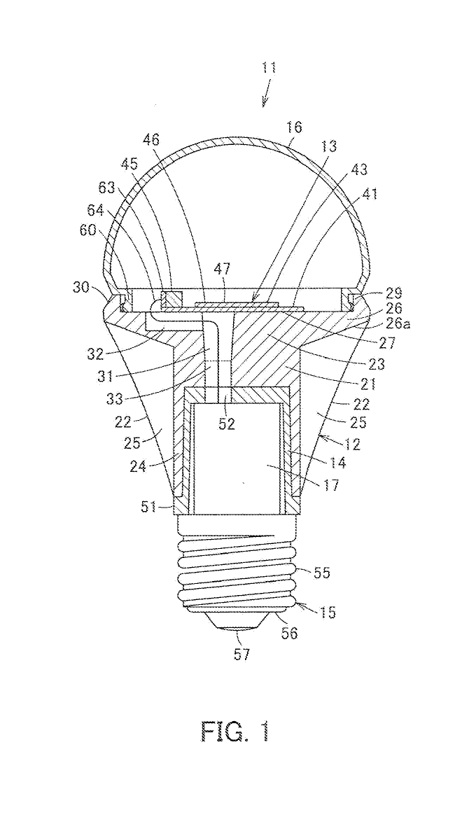

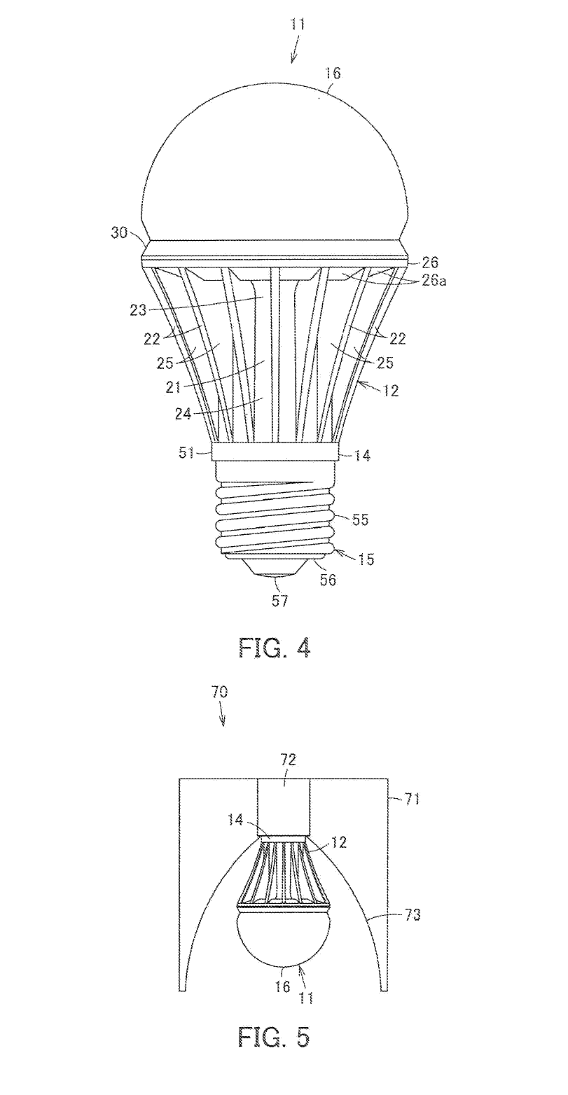

FIG. 1 through FIG. 5 show Embodiment 1.

In FIG. 1 through FIG. 4, reference numeral 11 denotes a self-ballasted lamp. The self-ballasted lamp is provided with a metal-made holder 12, a light emitting module 13 attached to one end side of the holder 12 (one end side of the lamp axis of the self-ballasted lamp 11), a cover 14 having an insulative property, which is attached to the other end side of the holder 12, a cap 15 attached to the other end side of the cover 14, a globe 16 having translucency, which is attached to one end side of the holder 12 and covers the light emitting module 13, and a lighting circuit 17 accommodated inside the cover 14 between the holder 12 and the cap 15.

The holder 12 is integrally formed of a metallic material such as, for example, aluminum which has excellent heat conductivity, and a main body portion 21 is formed at the middle area, wherein a plurality of heat radiation fins 22 radially protrude and are formed along the axial direction of the lamp at the circumference of the main body portion 21.

A columnar solid base portion 23 is formed at one end side of the main body portion 21, and a cylindrical portion 24 opened to the other end side is formed at the other end side of the main body portion 21.

The heat radiation fins 22 are formed to be inclined so that the protrusion amount in the diametrical direction gradually increases from the other end side of the holder 12 to one end side thereof. Also, these heat radiation fins 22 are radially formed substantially equidistantly to each other in the circumferential direction of the holder 12. A gap 25 is formed between these heat radiation fins 22. The gaps 25 are opened to the other end side of the holder 12 and to the surrounding thereof, and are closed at one end side of the holder. An annular edge portion 26 continued to the base portion 23 is formed at the circumference of the base portion 23 at one end side of the heat radiation fins 22 and the gaps 25. The edge part 26 is shaped so that one end side surface is flush with one end side surface of the base portion 23, and the other end side surface is made into a tapered surface 26a, wherein the thickness is varied so that the base portion 23 side becomes thick, and the distal end side (outer diametrical side) becomes thin. The tapered surface 26a of the edge part 26 is linked with one end portion of the heat radiating fins 22.

At the surface of one end side of the holder 12, a light emitting module mounting side 27 to which the light emitting module 13 is attached in a state where the light emitting module 13 is in surface contact with the surface at the surface of one end side of the base portion 23, which is the middle area, is formed, a plurality of attaching holes 28 for attaching the light emitting module to the light emitting module attaching side 27 by means of screws is formed, and an annular globe attaching part 29 for attaching the globe 16 to the surface of one end side of the edge part 26, which is the surrounding area, is formed so as to protrude. An inclined part 30 at which the globe 16 side, which is one end side, is made smaller in diameter is formed at the outer circumference of the globe attaching part 29.

At the base portion 23 of the holder 12, a hole portion 31 communicating the surface of one end side of the holder 12 and the inner side of the cylindrical portion 24, which is the other end side thereof, with each other is formed along the axial direction of the lamp at a position deviated from the center of the lamp axis, and a groove portion 32 is formed at the surface of one end side of the holder 12 from one end side of the hole portion 31 toward the surrounding area of the holder 12, wherein the hole portion 31 and the groove portion 32 form a wiring hole 33 for wiring connection between the lighting circuit 17 and the light emitting module 13.

And, the holder 12 has such a relationship that, when being observed from the surface of one end side of the holder 12, the capacity of the base portion 23 is greater than the capacity of the portion of the heat radiation fins, that is, the thermal capacity by which the base portion can absorb heat is greater than the thermal capacity of the portion of the heat radiation fins 22.

Also, the light emitting module 13 has a square substrate 41 formed of, for example, a metallic material such as aluminum, or an insulative material such as ceramic, epoxy resin, etc., wherein a wiring pattern 42 is formed on the mounting surface which is the surface of one end side of the substrate 41, and LED chips 43 operating as a plurality of semiconductor light emitting elements are arrayed and mounted in the matrix state at the middle area of the mounting surface.

A plurality of LED chips 43 are connected in series by wire bonding along the direction between a pair of electrode pads 44 of the wiring pattern 42 disposed in both side areas of the plurality of LED chips 43. At the edge part of the substrate 41, which is the edge part of the substrate 41 opposed to the groove portion 32 of the holder 12 in a state where the light emitting module 13 is attached to the holder 12, a connector receiver 45 electrically connected to the wiring pattern 42 is disposed.

For example, LED chips emitting blue light are used as the LED chips 43. For example, a sealing resin which is a transparent resin such as, for example, silicone resin, etc., is coated and formed on the plurality of LED chips 43 mounted on the substrate 41. A fluorescent body which is pumped by a part of blue-color light from the LED chip 43 and irradiates yellow light is blended in the sealing resin. Therefore, the light emitting portion 46 is composed of the LED chip 43 and the sealing resin, and the surface of the sealing resin, which is the surface of the light emitting portion 46, is made into a light emitting surface 47 that irradiates white-based illumination light.

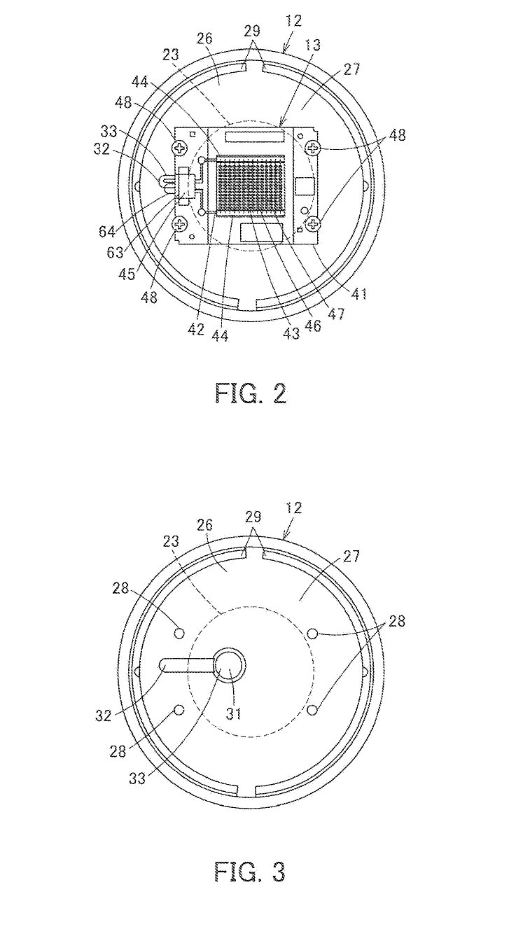

A plurality of insertion holes (not illustrated) are formed in the vicinity of four corners of the substrate 41, and screws 48 which are inserted into these insertion holes are screwed in the attaching holes 28 of the holder 12, wherein the substrate 41 is mounted in a state where the surface of the other end side of the substrate 41 is in surface contact with the light emitting module attaching surface 27 which is the surface of one end side of the base portion 23 of the holder 12. At this time, a heat conduction material such as, a sheet or grease, which is excellent in heat conductivity, intervenes between the surface of the other end side of the substrate 41 and the light emitting module attaching surface 27 of the holder 12. And, in a state where the substrate 41 is attached to the light emitting module attaching surface 27 of the holder 12, the center of the light emitting surface 47 is positioned so as to correspond to the center of the lamp axis, and the light emitting portion 46 of the light emitting module 13 is located in a projection area (an area depicted by dashed lines in FIG. 2 and FIG. 3) of the base portion 23, which is depicted on one end side of the holder 12. In other words, the light emitting portion 46 of the light emitting module 13 is located in an area where the heat radiation fins 22 are not formed, and the end portion of the groove portion 32 of the wiring hole 33 is exposed from the edge part of the substrate 41 and opened therefrom. In addition, the heat conduction is excellent if the substrate 41 is brought into surface contact with the light emitting module attaching surface 27 so that 90% or more, or favorably 95% or more of the light emitting portion 46 exists in the area, wherein it has been confirmed that a predetermined heat radiation effect can be obtained.

Further, the cover 14 is formed of an insulative material such as, for example, PBT resin, to become cylindrical so as to be opened toward the other end side. An annular collar portion 51 which intervenes between the holder 12 and the cap 15 and insulates them is formed at the outer circumferential portion at the other end side of the cover 14. A wiring hole 52 coaxially communicating with the wiring hole 33 of the holder 12 is formed at the surface of one end side of the cover 14.

Further, the cap 15 is that which can be connected to a socket of, for example, an E17 or E26 type general illumination bulb, and includes a shell 55 fitted in and fixed by being caulked in the cover 14, an insulative portion 56 provided at the other end side of the shell 55, and an eyelet 57 provided at the top part of the insulative portion 56.

In addition, the globe 16 is formed of glass or a synthetic resin, which has a light diffusion property, to become spherical so as to cover the light emitting module 13. The other end side of the globe 16 is opened, and a fitting portion 60 which is fitted in the inner circumferential side of the globe attaching part 29 of the holder 12 and is fixed with an adhesive agent is formed in the opened edge portion.

Also, the lighting circuit 17 is a circuit which supplies a fixed current to, for example, the LED chips 43 of the light emitting module 13, and has a circuit substrate having a plurality of circuit elements, which composes the circuit, mounted thereon. The circuit substrate is accommodated and fixed in the cover 14. The shell 55 and the eyelet 57 of the cap 15 are electrically connected to the input side of the lighting circuit 17 by a connection wire. A connection wire 64 having a connector 63 at its tip end is connected to the output side of the lighting circuit 17. The connector 63 and the connection wire 64 are led to one end side of the holder 12 through the wiring hole 52 of the cover 14 and the wiring hole 33 of the holder 12, and the connector 63 is connected to the connector receiver 45 of the substrate 41. Also, the connection work with the light emitting model 13 is carried out before the light emitting module 13 is screwed to the holder 12.

In addition, FIG. 5 shows lighting equipment 70 which is a downlight using the self-ballasted lamp 11. The lighting equipment 70 has an equipment main body 71 in which a socket 72 and a reflector 73 are disposed.

Thus, if the self-ballasted lamp 11 is mounted in the socket 72 of the lighting equipment 70 and an electric current is supplied, the lighting circuit 17 operates and power is supplied to a plurality of LED chips 43 of the light emitting module 13, and a plurality of LED chips 43 emit light, wherein the light is diffused and irradiated through the globe 16.

Heat generated when a plurality of LED chips 43 of the light emitting module 13 are lit is conducted to the substrate 41, and is radiated from the substrate 41 to the base portion 23 of the holder 12. The heat is further thermally conducted from the base portion 23 to a plurality of heat radiation fins 22, and is efficiently radiated from the plurality of heat radiation fins 22 into the atmosphere.

Also, heat that is generated when a plurality of LED chips 43 of the light emitting module 13 are lit is conducted from the base portion 23 to the edge part 26. Further, since the edge part 26 is thickened at the base portion 23 side, the thermal capacity of this portion is increased, wherein heat conduction from the base portion 23 to the edge portion 26 can be improved, and heat can be radiated from the edge portion 26.

In addition, since the tapered surface 26a of the edge part 26 is linked with one end portion of the heat radiating fins 22, heat conduction is mutually enabled between the edge part 26 and the heat radiating fins 22, wherein heat can be efficiently radiated from both of the edge part 26 and the heat radiating fins 22.

Also, the holder 12 has such a relationship that, when being observed from the surface one end side of the holder 12, the capacity of the base portion 23 is greater than the capacity of the portion of the heat radiation fins 22, that is, the thermal capacity by which the base portion 23 can absorb heat is greater than the thermal capacity of the portion of the heat radiation fins 22. Therefore, the light emitting portion 46 of the light emitting module 13 being positioned at an area at one end side of the base portion 23, preferably, in the area thereof, heat from a plurality of LED chips 43 can be efficiently and continuously absorbed by the base portion 23 having a great thermal capacity, the heat can be efficiently conducted to the base portion 23 of the holder 12, and heat conduction from the base portion 23 to the heat radiation fins 22 is made favorable, wherein the heat can be efficiently radiated outside by the heat radiation fins 22, and the temperature rise of the LED chips 43 can be effectively prevented.

In addition, since the wiring hole 33 is formed by the hole portion 31 communicating one end side of the base portion 23 of the holder 12 and the other end side thereof with each other and the groove portion 32 formed on the surface of one end side of the holder 12 from one end side of the hole portion 31 toward the surrounding area of the holder 12, wiring connection between the lighting circuit 17 and the light emitting module 13 can be facilitated while maintaining heat conductivity from the light emitting module 13 to the holder 12.

In particular, since the hole portion 31 of the wiring hole 33 is formed at a position deviated from the center of the base portion 23, heat from the LED chips 43 can be efficiently conducted to the center of the base portion 23 even if the LED chips 43 of the light emitting module 13 are disposed at a position corresponding to the center of the base portion 23 in view of taking light distribution as a self-ballasted lamp 11 into consideration.

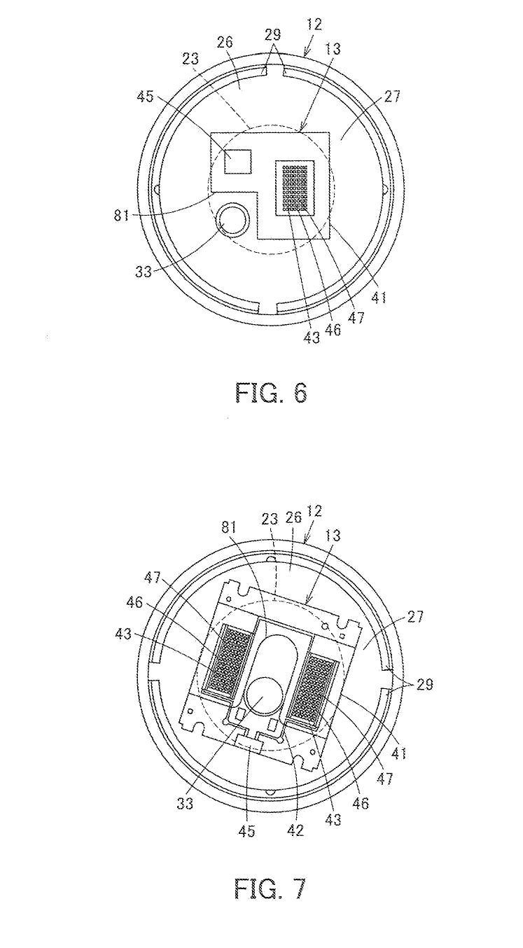

Next, FIG. 6 shows Embodiment 2. FIG. 6 is a front elevational view showing a holder and a light emitting module of a self-ballasted lamp when being observed from one end side thereof.

A wiring hole 33 which communicates one end side of the holder 12 and the other end side thereof with each other is formed at the position of the base portion 23 and at a position deviated from the center of the lamp axis.

The substrate 41 of the light emitting module 13 is substantially square-shaped, and one of the corners is notched to form a relief portion 81.

When the light emitting module 13 is attached to the holder 12, the wiring hole 33 is devised to be opened in a state where the relief portion 81 of the substrate 41 is matched to the position of the wiring hole 33.

Accordingly, wiring connection between the lighting circuit 17 and the light emitting module 13 through the wiring hole 33 can be facilitated while maintaining high heat conductivity from the light emitting module 13 to the holder 12 with the entire surface of the substrate 41 brought into contact with the base portion 23 of the holder 12.

Further, since the relief portion 81 is formed in the substrate 41, the center of the light emitting surface 47 of the light emitting module 13 can be approached to the center of the lamp axis, wherein uniform light distribution characteristics can be brought about.

Next, FIG. 7 shows Embodiment 3, which is a front elevational view showing a holder of a self-ballasted lamp and a light emitting module when being observed from one end side thereof.

In the holder 12, a wiring hole 33 which communicates one end side of the holder 12 and the other end side thereof with each other is formed at the position of the base portion 23 and at a position deviated from the center of the lamp axis.

The substrate 41 of the light emitting module 13 is substantially square-shaped, and a long slot-shaped relief portion 81 is formed in the middle area.

When the light emitting module 13 is attached to the holder 12, the wiring hole 33 is devised to be opened in a state where the long slot-shaped relief portion 81 of the substrate 41 is matched to the position of the wiring hole 33.

Accordingly, wiring connection between the lighting circuit 17 and the light emitting module 13 through the wiring hole 33 can be facilitated while maintaining high heat conductivity from the light emitting module 13 to the holder 12 with the entire surface of the substrate 41 brought into contact with the base portion 23 of the holder 12.

Further, since the long slot-shaped relief portion 81 is formed with LED chips 43 divided and disposed on both sides thereof, on the substrate 41, uniform light distribution characteristics can be brought about while the substrate 41 has the long slot-shaped relief portion 81 in the middle area.

Also, although the relief portion 81 is made long slot-shaped, the relief portion may be formed to be like a substantially U-shaped groove.

In addition, where the LED chips 43 are divided and disposed, the substrate 41 itself may be divided. For example, the substrate 41 is formed to be substantially L-shaped, a pair of substrates 41 are combined like a square-shaped frame, and are fixed on the holder 12, and a pair of substrates 41 may be electrically connected to each other by wire bonding or soldering connection.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A self-ballasted lamp comprising:
a light emitting module having a light emitting portion having a plurality of semiconductor light emitting elements mounted on the surface of one side of a substrate;
a holder which has a base portion, an edge part provided at one end side of the base portion, which is thick at the base portion side and is thin at the distal end side, and heat radiating fins provided at the other end part side of the edge part and at the circumference of the base portion and in which the surface of the other side of the substrate is brought into contact with one end side of the base portion so as to enable heat conduction so that the light emitting portion of the light emitting module is positioned in an area at one end side of the base portion;
a cap provided at the other end side of the holder; and
a lighting circuit accommodated between the base portion of the holder and the cap.

2. The self-ballasted lamp according to claim 1, wherein the edge part is shaped so that one end side surface thereof is flush with the base portion, and the other end side surface thereof is made into a tapered surface.

3. The self-ballasted lamp according to claim 2, wherein the tapered surface of the edge part is linked with the end portion of the heat radiating fins.

4. The self-ballasted lamp according to any one of claim 1, wherein the thermal capacity of the base portion is greater than the heat radiating fins.

5. The self-ballasted lamp according to any one of claim 1, wherein a wiring hole which communicates one edge side of the base portion and the other edge side thereof with each other and enables wiring connection between the light emitting module and the lighting circuit is formed at the holder, and
a relief portion which causes the wiring hole to be opened in a state where the substrate is in contact with the base portion is formed at the substrate of the light emitting module.

6. The self-ballasted lamp according to any one of claim 1, wherein a hole portion which communicates one edge side of the base portion and the other edge side thereof with each other is formed at the holder, and a groove portion is formed on the surface of one edge side of the holder from one edge side of the hole portion toward the surrounding area of the holder is formed, and a wiring hole which enables wiring connection between the light emitting module and the lighting circuit is formed by the hole portion and the groove portion.

7. Lighting equipment comprising:
an equipment main body having a socket; and
a self-ballasted lamp according to any one of claims claim 1 through 6, which is mounted in the socket of the equipment main body.

8. The self-ballasted lamp according to claim 2, wherein the thermal capacity of the base portion is greater than the heat radiating fins.

9. The self-ballasted lamp according to claim 3, wherein the thermal capacity of the base portion is greater than the heat radiating fins.

10. The self-ballasted lamp according to claim 2, wherein a wiring hole which communicates one edge side of the base portion and the other edge side thereof with each other and enables wiring connection between the light emitting module and the lighting circuit is formed at the holder, and
a relief portion which causes the wiring hole to be opened in a state where the substrate is in contact with the base portion is formed at the substrate of the light emitting module.

11. The self-ballasted lamp according to claim 3, wherein a wiring hole which communicates one edge side of the base portion and the other edge side thereof with each other and enables wiring connection between the light emitting module and the lighting circuit is formed at the holder, and
a relief portion which causes the wiring hole to be opened in a state where the substrate is in contact with the base portion is formed at the substrate of the light emitting module.

12. The self-ballasted lamp according to claim 4, wherein a wiring hole which communicates one edge side of the base portion and the other edge side thereof with each other and enables wiring connection between the light emitting module and the lighting circuit is formed at the holder, and
a relief portion which causes the wiring hole to be opened in a state where the substrate is in contact with the base portion is formed at the substrate of the light emitting module.

13. The self-ballasted lamp according to claim 2, wherein a hole portion which communicates one edge side of the base portion and the other edge side thereof with each other is formed at the holder, and a groove portion is formed on the surface of one edge side of the holder from one edge side of the hole portion toward the surrounding area of the holder is formed, and a wiring hole which enables wiring connection between the light emitting module and the lighting circuit is formed by the hole portion and the groove portion.

14. The self-ballasted lamp according to claim 3, wherein a hole portion which communicates one edge side of the base portion and the other edge side thereof with each other is formed at the holder, and a groove portion is formed on the surface of one edge side of the holder from one edge side of the hole portion toward the surrounding area of the holder is formed, and a wiring hole which enables wiring connection between the light emitting module and the lighting circuit is formed by the hole portion and the groove portion.

15. The self-ballasted lamp according to claim 4, wherein a hole portion which communicates one edge side of the base portion and the other edge side thereof with each other is formed at the holder, and a groove portion is formed on the surface of one edge side of the holder from one edge side of the hole portion toward the surrounding area of the holder is formed, and a wiring hole which enables wiring connection between the light emitting module and the lighting circuit is formed by the hole portion and the groove portion.

16. Lighting equipment comprising:
an equipment main body having a socket; and
a self-ballasted lamp according to claim 2, which is mounted in the socket of the equipment main body.

17. Lighting equipment comprising:
an equipment main body having a socket; and
a self-ballasted lamp according to claim 3, which is mounted in the socket of the equipment main body.

18. Lighting equipment comprising:
an equipment main body having a socket; and
a self-ballasted lamp according to claim 4, which is mounted in the socket of the equipment main body.

19. Lighting equipment comprising:
an equipment main body having a socket; and
a self-ballasted lamp according to claim 5, which is mounted in the socket of the equipment main body.

20. Lighting equipment comprising:
an equipment main body having a socket; and
a self-ballasted lamp according to claim 6, which is mounted in the socket of the equipment main body.
